(19) United States
(12) Patent Application Publication
(10) Pub. No.: US 2026/0200121 A1
(43) Pub. Date: Jul. 16, 2026

(54) CHAIN SAW

(71) Applicant: JIANGSU DONGCHENG M&E TOOLS CO., LTD., Nantong (CN)

(72) Inventors: Zhenliang WANG, Nantong (CN); Wenbin LU, Nantong (CN); Gongyuan FAN, Nantong (CN)

(21) Appl. No.: 19/134,332

(22) PCT Filed: Jun. 29, 2023
(86) PCT No.: PCT/CN2023/103554

§ 371 Date: May 30, 2025

(30) Foreign Application Priority Data
Nov. 30, 2022 (CN) 202211518265.1

(51) Int. Cl. B27B 17/00; B27B 17/14

(52) U.S. Cl. CPC B27B 17/0033; B27B 17/142

(57) ABSTRACT

The present invention relates to a chain saw, provided with a guide plate extending in a longitudinal direction and a chain sleeved on the periphery of the guide plate. The chain saw comprises a housing, a driving assembly and a chain wheel connected to the driving assembly; the driving assembly comprises a driving shaft extending out of the housing in an axial direction; the chain wheel is sleeved at the axial tail end of the driving shaft, the chain is at least partially wound on the chain wheel, and the driving shaft drives, by means of the chain wheel, the chain to rotate along the periphery of the guide plate; the chain saw comprises a supporting assembly installed on the axial outer side of the chain wheel, and the supporting assembly abuts against at least one of the chain and the chain wheel in the axial direction. In the present application, the chain is pressed in advance by means of the supporting assembly, and when a chain wheel cover is installed, a user does not need to additionally support the other end of the guide plate, so that time and labor are saved; moreover, the situation where due to the roughness of the guide plate, the chain is in excessive contact with a gasket to be stuck, resulting in the device failing to start up after the chain is tightened can be avoided. In addition, a wave-shaped pressing plate of the supporting assembly compensates for an axial gap at the chain wheel, thereby avoiding axial movement between parts, and effectively reducing noise.

### FIELD

The present invention relates to the field of garden tools, and in particular to a chain saw with low noise, low vibration and easy tensioning.

### BACKGROUND

Chain saw as a garden tool including a housing, a driving assembly fixed in the housing, a guide plate and a cover detachably installed on the housing, and a chain sleeved on the outer periphery of the guide plate. The driving assembly drives the chain to rotate around the outer periphery of the guide plate, thereby achieving cutting of wood and other workpieces. In order to prevent the chain from loosening after running for a period of time, a chain saw is generally provided with a chain tensioning structure on the detachable cover.

During installation, the user needs to fix the guide plate on the housing, then put the chain on the outer periphery of the guide plate, and then lock the cover to the housing to completely fix the guide plate and chain between the cover and the housing. Due to the guide plate is very long, it is only fixed to the housing through one longitudinal end, and the remaining long section including the center of gravity is in a suspended position, which makes the guide plate easy to tilt up; when installing the cover, the user needs to use one hand to straighten the guide plate, and another hand to operate the chain tensioning structure and lock the cover, which is time-consuming and laborious; on another hand, due to the unevenness of the guide plate, it will be warped near the sprocket, and when the chain is locked, the spacer at the sprocket and the chain will contact excessively and jam the chain, which will lead to the chain not being able to be opened after locking, or the teeth will fall off, which is a risk of injuring people.

At present, with the increasing popularity of garden tools on the market, users are becoming more and more concerned about the noise and vibration problems during the operation of garden tools, and noise and vibration will aggravate the wear and tear between the various parts of the garden tools, through the reduction of noise and vibration can also extend the life of the garden tools. Chain saws as a relatively high popularity of garden tools, and how to reduce noise and vibration is also a barrier that chain saws need to break through.

In view of this, it is indeed necessary to provide an improved chain saw to overcome the deficiencies of the prior art.

### SUMMARY

In view of the deficiencies of the prior art, an object of the present invention is to provide a chain saw with low noise, low vibration and easy tensioning.

The present application solves the problems of the prior art by adopting the following technical solutions: a chain saw comprises a guide plate extending in a longitudinal direction, a chain sleeved on an outer periphery of the guide plate, a housing, a driving assembly arranged in the housing and a sprocket connected to the driving assembly, the driving assembly comprises a driving shaft extending out of the housing in an axial direction perpendicular to the longitudinal direction, the sprocket is sleeved on an axial end of the driving shaft, the chain is at least partially wound around the sprocket, and the driving shaft drives the chain to rotate along the outer periphery of the guide plate through the sprocket; wherein: the chain saw comprises a supporting assembly connected to an axially outer side of the sprocket, the supporting assembly is axially connected to the driving shaft and presses against at least one of the chain and the sprocket in the axial direction

The present application further discloses that: the supporting assembly comprises a plurality of extension members extending toward the chain and axially pressing the chain, the plurality of extension members press against the chain at intervals, so that a front end and a rear end of the guide plate are kept horizontal in the longitudinal direction The present application further discloses that: the supporting assembly comprises a pressure plate arranged on an axial outside side of the sprocket, the pressure plate is provided with an inner ring portion sleeved on the driving shaft and an outer ring portion extending in a wave shape on an outer periphery of the inner ring portion, the outer ring portion axially presses an outer end surface of the sprocket to compensate for an axial gap between the sprocket and the housing.

The present application further discloses that: the extension member is configured as a plurality of spring tongues extending from the outer ring portion toward the chain, and the spring tongues are set at intervals on the outer periphery of the inner ring portion.

The present application further discloses that: the sprocket comprises a sleeve portion sleeved on the driving shaft and a plurality of teeth extending axially from an outer surface of the sleeve portion, and each spring tongue extends into a gap between two adjacent teeth and presses against an outer surface of the chain.

The present application further discloses that: the sprocket comprises a sleeve portion sleeved on the driving shaft, a plurality of teeth axially extending from an outer surface of the sleeve portion, and an end portion connecting the plurality of the teeth, the extension member is configured as a protrusion block extending from an inner side wall of the end portion toward the chain and pressing against the chain, and the protrusion block is integrally formed with the end portion.

The present application further discloses that: the supporting assembly comprises a pressure plate that presses against the end portion, and the pressure plate is configured as a wavy elastic plate to compensate for the axial gap between the sprocket and the chain.

The present application further discloses that: the driving shaft extends axially out of the housing, the chain saw comprises a spacer connected to an axial end of the driving shaft, and the supporting assembly is elastically connected between the sprocket and the spacer to compensate for an axial gap between the sprocket and the spacer.

The present application further discloses that: the chain saw comprises a cover detachably connected to the housing and a pressing member fixed in the cover, and when the cover is connected to the housing, the pressing member presses against an outer surface of the guide plate.

The present application further discloses that: the pressing member comprises a fixing plate installed on an inner surface of the cover and a pressing portion extending from the fixing plate toward the guide plate, and when the cover is connected to the housing, the pressing portion axially presses against a rear end of the guide plate, so that the guide plate remains horizontal in the longitudinal direction.

Compared with the prior art, the present application has the following beneficial effects: by installing a supporting assembly on the axial outer side of the sprocket, the supporting assembly includes an extension member that presses against the chain in the axial direction, when the cover is installed, the user does not need to additionally support the other end of the guide plate to operate the tensioning structure, saving time and effort; and the extension member pre-presses against the chain and remains the guide plate horizontal in the longitudinal direction, ensuring that the chain is in a suitable locking position, the situation where excessive contact between the chain and the spacer caused by the uneven height of the guide plate causes the chain to get stuck and result in the chain being unable to start or teeth falling off after being tightened may be avoided; in addition, the axial gap between the sprocket and the housing is compensated by wave-shaped pressure plate of the supporting assembly, thereby reducing the vibration between the parts and effectively reducing the noise.

### BRIEF DESCRIPTION OF THE DRAWINGS

The specific embodiments of the present application are described in further detail below in conjunction with the accompanying drawings:

FIG. 1 is a schematic structural diagram of a chain saw in a preferred embodiment of the present application;

FIG. 2 is a partial exploded view of the chain saw shown in FIG. 1 after a cover is removed;

FIG. 3 is a partial sectional view of the assembly of the cover and a housing in the chain saw shown in FIG. 1;

FIG. 4 is a partial sectional view of a sprocket shown in FIG. 3;

FIG. 5 is a schematic structural diagram of the sprocket shown in FIG. 4;

FIG. 6 is a schematic structural diagram of a supporting assembly shown in FIG. 5;

FIG. 7 is a sectional view of the cover of the chain saw shown in FIG. 1;

FIG. 8 is a schematic structural diagram of a pressing member of the cover shown in FIG. 7;

FIG. 9 is a schematic structural diagram of a sprocket according to another embodiment of the present application;

FIG. 10 is a schematic structural diagram of a supporting assembly according to another embodiment of the present application.

### DETAILED DESCRIPTION

The present application is further described in detail below in conjunction with the accompanying drawings and embodiments.

The terms used in the present application are only for the purpose of describing specific embodiments and are not intended to limit the present application. For example, the following words “up”, “down”, “front”, “back”, “left”, “right”, etc., indicating orientation or positional relationships, are based on the orientation or positional relationships shown in the accompanying figures, and are only for the convenience of describing the simplified description of the present application, rather than indicating or implying that the device/element referred to must have a specific orientation or be constructed and operated in a specific orientation, and therefore cannot be understood as limiting the present application.

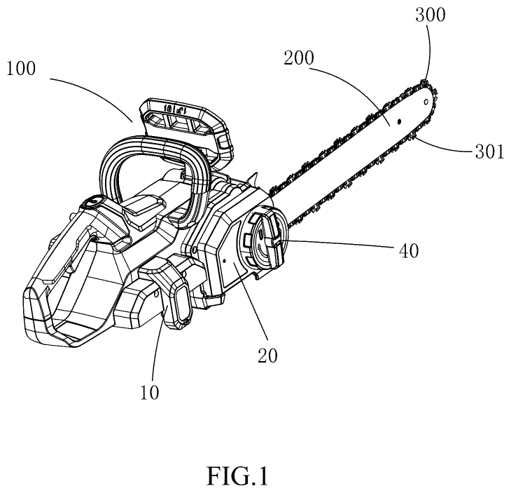

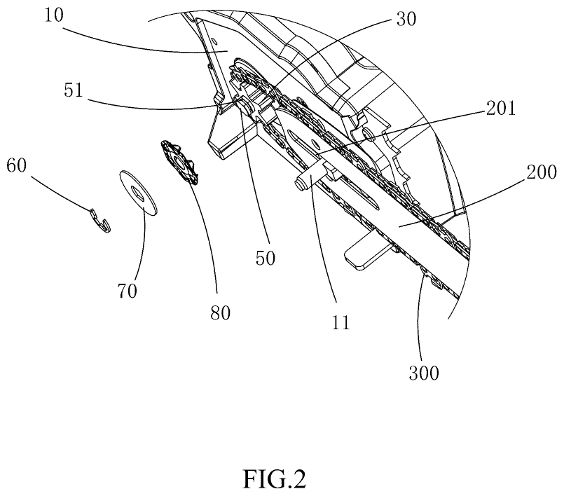

Referring to FIGS. 1 and 2, an embodiment of the present application relates to a chain saw 100, and the chain saw 100 is installed with a guide plate 200 extending in a longitudinal direction and a chain 300 sleeved on an outer periphery of the guide plate 200. The chain saw 100 includes a housing 10, a cover 20 detachably installed on the housing 10, a driving assembly disposed in the housing 10, and a sprocket 30 connected to the driving assembly. The driving assembly includes a motor (not shown in the figures), a transmission device (not shown) connected to the motor, and a driving shaft 50 connected to the transmission device, the driving shaft 50 extends out of the outer surface of the housing 10 in an axial direction perpendicular to the longitudinal direction, the chain 300 is at least partially wound around the sprocket 30, and the sprocket 30 is sleeved on an axial end of the driving shaft 50. The driving shaft 50 drives the chain 300 to rotate along the outer periphery of the guide plate 200 through the sprocket 30, thereby realizing a cutting operation.

In the embodiment, the housing 10 includes a positioning column 11 extending axially out of the outer surface of the housing 10, and the guide plate 200 includes a limiting groove 201 extending longitudinally and penetrating the guide plate 200. The positioning column 11 passes through the limiting groove 201 and extends into the cover 20 to fix the guide plate 200 on the outer surface of the housing 10.

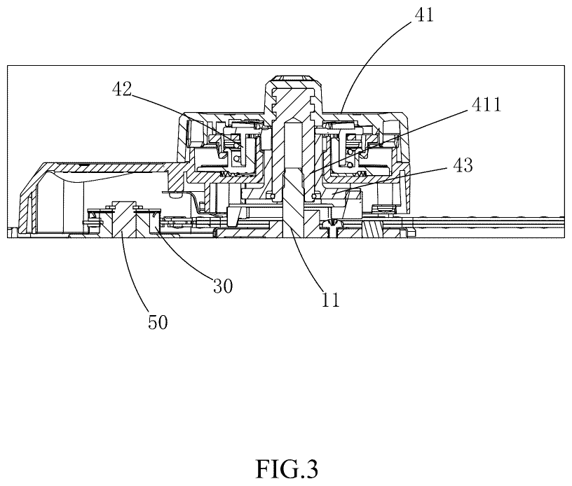

Referring to FIG. 3, the chain saw 100 includes a chain tensioning structure 40 fixed on the cover 20, the chain tensioning structure 40 includes a lock button 41 for user operation, a tensioning transmission device 42 fixed between the lock button 41 and the cover 20, and an eccentric cam 43 fixed on a side of the cover 20 away from the lock button 41. The lock button 41 includes an axially extending locking member 411, and the eccentric cam 43 is sleeved on the locking member 411. When the cover 20 is installed on the housing 10, the positioning column 11 extends into the locking member 411 and is threadedly matched with the locking member 411 to fix the guide plate 200 between the cover 20 and the housing 10; when the lock button 41 is rotated, the lock button 41 drives the tensioning transmission device 42 and the eccentric cam 43 to rotate, and the eccentric cam 43 drives the guide plate 200 to move longitudinally along the limiting groove 201, thereby realizing the tensioning of the chain 300.

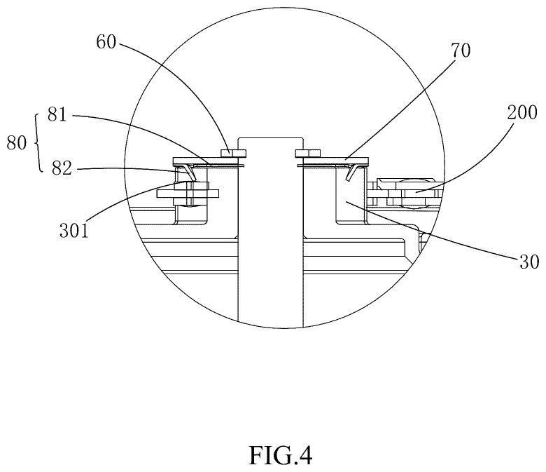

Referring to FIGS. 4 and 5, the driving shaft 50 is located at a rear end of the guide plate 200 in the longitudinal direction, and the sprocket 30 is sleeved on the driving shaft 50 and rotates together with the driving shaft 50. The sprocket 30 includes a sleeve portion 31 sleeved on the driving shaft 50 and a plurality of teeth 32 extending axially from the outer surface of the sleeve portion 31, and the chain 300 is partially wound around the teeth 32 and rotates together with the teeth 32.

The chain saw 100 further includes a stopper 60 installed on the axial end of the driving shaft 50, a spacer 70 installed between the stopper 60 and the sprocket 30 in the axial direction, and a supporting assembly 80 installed between the spacer 70 and the sprocket 30 in the axial direction. A stop groove 51 is defined at the axial end of the driving shaft 50, and the stopper 60 is installed in the stop groove 51 to limit the axial movement of the spacer 70 and the supporting assembly 80.

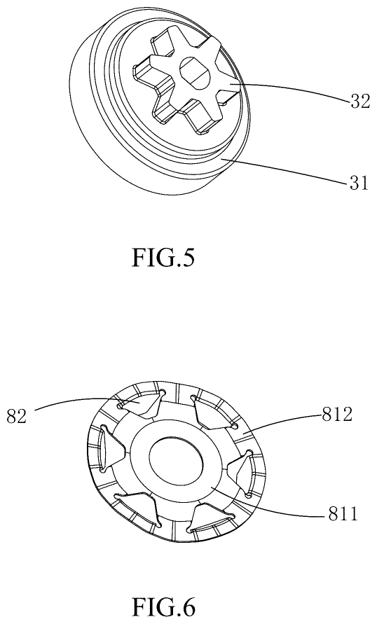

Referring to FIG. 6, the supporting assembly 80 is axially fixed to the driving shaft 50 and presses against at least one of the chain 300 and the sprocket 30 in the axial direction. The supporting assembly 80 includes a pressure plate 81 arranged on an axial outer side of the sprocket 30, and the pressure plate 81 is constructed as a metal plate and has a certain elasticity. The pressure plate 81 includes an inner ring portion 811 sleeved on the driving shaft 50 and an outer ring portion 812 extending in a wave shape on an outer periphery of the inner ring portion 811. The inner ring portion 811 defines a through hole for the driving shaft 50 to pass through, and the outer ring portion 812 presses against the axial outer end surface of the plurality of teeth 32 of the sprocket 30 to compensate for the axial gap between the sprocket 30, the spacer 70, the stopper 60 and the housing 10, thereby avoiding the axial movement between the various parts that may cause startup noise and effectively reducing vibration.

The supporting assembly 80 further includes a plurality of extension members 82 extending toward the chain 300 and axially pressing the chain 300. The plurality of extension members 82 press the chain 300 at intervals to keep the guide plate 200 for installing the chain 300 horizontal in the longitudinal direction at the front and rear ends. The extension member 82 is configured as a plurality of spring tongues extending from the outer ring portion 812 of the pressure plate 81 toward the chain 300, the spring tongues are set at intervals on the outer periphery of the inner ring portion 811, and each spring tongue extends between adjacent teeth 32 to press against the outer surface of the chain 300, and the number of the spring tongues is equal to the number of the teeth 32.

Referring to FIGS. 1 and 4, the chain 300 includes a plurality of links 301 connected to each other, each link 301 respectively includes a cutting piece, a connecting piece, and a driving piece. When the chain 300 is tensioned, each spring tongue presses against a link 301 and rotates together with the chain 300 to maintain an appropriate installation gap between the chain 300 and the spacer 70, thereby avoiding excessive tension of the chain 300 and affecting tool use.

The pressure plate 81 of the supporting assembly 80 is elastically installed between the sprocket 30 and the spacer 70 to compensate for the axial gap between the sprocket 30 and the stopper 60 and the spacer 70, thereby avoiding vibration caused by axial movement between the stopper 60, the spacer 70, the sprocket 30 and the housing 10, and effectively reducing the friction among the four, thereby extending the life of the entire machine; the extension member 82 of the supporting assembly 80 extends axially between the teeth 32 of the sprocket 30 to press against the chain 300 wrapped around the sprocket 30. When the chain 300 is tensioned, the user does not need to additionally support the other end of the guide plate 200 to operate the tensioning structure, saving time and effort.

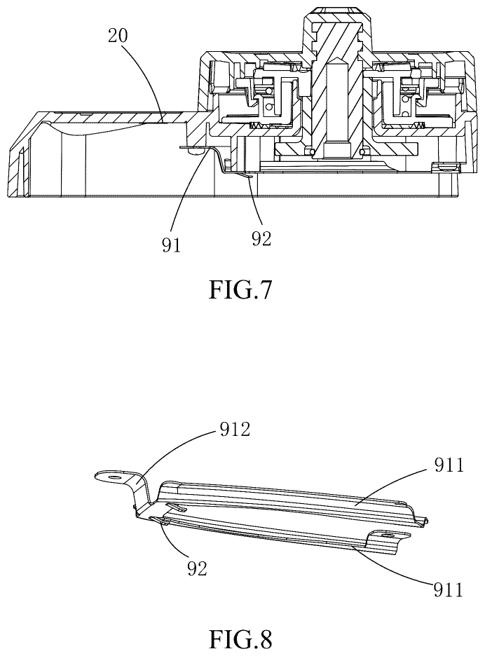

Referring to FIGS. 7 and 8, the chain saw 100 further includes a pressing member 90 installed on the cover 20, and the pressing member 90 includes a fixing plate 91 installed on an inner surface of the cover 20 close to the housing 10 and a pressing portion 92 extending from the fixing plate 91 toward the guide plate 200. When the cover 20 is installed to the housing 10, the pressing portion 92 presses against the outer surface of the longitudinal rear end of the guide plate 200, so that the front and rear ends of the guide plate 200 remain horizontal in the longitudinal direction.

The fixing plate 91 includes a pair of installing arms 911 extending longitudinally and arranged in parallel and connected to each other, and the longitudinal front ends of the two installing arms 911 are respectively provided with screw holes. The longitudinal rear ends of the two installing arms 911 are connected to each other and provided with a connecting portion 912 bent toward the cover 20. The connecting portion 912 is also provided with a screw hole. The fixing plate 91 is fixed to the cover 20 by passing three screws through the three screw holes. As shown in FIG. 2, the pressing portion 92 is configured as elastic contact pieces extending along the longitudinal direction and towards the guide plate 200 from the connection between the connecting portion 912 and the pair of the installing arms 911, and the elastic contact pieces are respectively located at opposite sides of the limit groove 201. When the cover 20 is installed on the housing 10, the elastic contact pieces pre-press the opposite sides of the limit groove 201 of the guide plate 200, so that the guide plate 200 remains horizontal in the longitudinal direction, effectively solving the problem of the guide plate 200 warping up during tensioning existing in the market, and having higher safety. The fixing plate 91 and the pressing portion 92 are integrally formed metal material parts.

When the chain saw 100 of the present application is installed with the cover 20, the extension member 82 of the supporting assembly 80 pre-presses against the chain 300, and the pressing portion 92 of the pressing member 90 pre-presses against the guide plate 200, so that the guide plate 200 remains horizontal in the longitudinal direction, the situation where excessive contact between the chain 300 and the spacer 70 causes the chain 300 to get stuck and result in the chain 300 being unable to start or teeth falling off after being tightened may be avoided when tightening the chain 300 by rotating the lock button 41, and the structure is simple and easy to tighten. In addition, the axial gap between the sprocket 30 and other parts is compensated by the pressing plate 81 of the supporting assembly 80, avoiding mutual movement or friction between the various parts, effectively reducing vibration and noise, and extending the life of the whole machine.

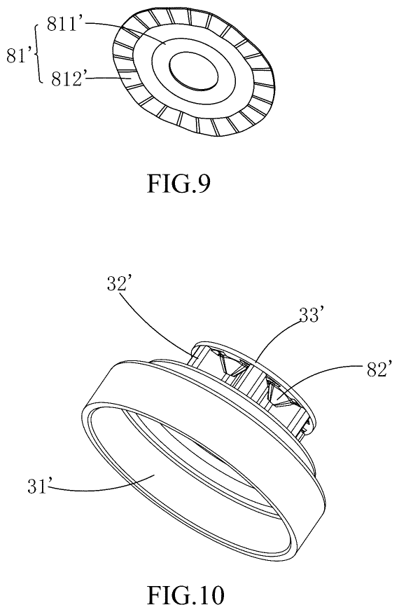

FIGS. 9 and 10 show another embodiment of the supporting assembly of the present application, the supporting assembly includes a pressure plate 81′ sleeved on a driving shaft (not shown in the figures) and a plurality of extension members 82′ for pressing against a chain (not shown in the figures). The sprocket 30′ includes a sleeve portion 31′ sleeved on the driving shaft, a plurality of teeth 32′ axially extending from the outer surface of the sleeve portion 31′, and an end portion 33′ connecting the axial ends of the plurality of teeth 32′. The extension member is configured as a protrusion block extending from an inner side wall of the end portion 33′ toward the chain and pressing against the chain, and the protrusion block is integrally formed with the end portion 33′ and the sprocket 30′.

The pressure plate 81′ includes an inner ring portion 811′ sleeved on the driving shaft and an outer ring portion 812′ extending from an outer periphery of the inner ring portion 811′. The outer ring portion 812′ is configured as a wavy elastic plate, and the outer ring portion 812′ axially presses against the outer surface of the end portion 33′ to compensate for the axial gap between the sprocket 30′ and other parts, avoiding mutual movement or friction between the various parts of the sprocket 30′, effectively reducing vibration and noise, and extending the life of the whole machine.

The other structures of the embodiment are the same as those of the above embodiment and will not be elaborated here.

The present application is not limited to the above specific implementations. Those skilled in the art can easily understand that there are many other alternatives to the present application without departing from the principle and scope of the present application. The protection scope of the present application shall be subject to the content of the claims.

1. A chain saw comprising:
a guide plate extending in a longitudinal direction;
a chain sleeved on an outer periphery of the guide plate;
a housing;
a driving assembly arranged in the housing;
a sprocket connected to the driving assembly;
the driving assembly comprises a driving shaft extending out of the housing in an axial direction perpendicular to the longitudinal direction, the sprocket is sleeved on an axial end of the driving shaft, the chain is at least partially wound around the sprocket, and the driving shaft drives the chain to rotate along the outer periphery of the guide plate through the sprocket; wherein:
the chain saw comprises a supporting assembly connected to an axially outer side of the sprocket, the supporting assembly is axially connected to the driving shaft and presses against at least one of the chain and the sprocket in the axial direction.

2. The chain saw according to claim 1, wherein the supporting assembly comprises a plurality of extension members extending toward the chain and axially pressing the chain, the plurality of extension members press against the chain at intervals, so that a front end and a rear end of the guide plate are kept horizontal in the longitudinal direction.

3. The chain saw according to claim 2, wherein the supporting assembly comprises a pressure plate arranged on an axial outside side of the sprocket, the pressure plate is provided with an inner ring portion sleeved on the driving shaft and an outer ring portion extending in a wave shape on an outer periphery of the inner ring portion, the outer ring portion axially presses an outer end surface of the sprocket to compensate for an axial gap between the sprocket and the housing.

4. The chain saw according to claim 3, wherein the extension member is configured as a plurality of spring tongues extending from the outer ring portion toward the chain, and the spring tongues are set at intervals on the outer periphery of the inner ring portion.

5. The chain saw according to claim 4, wherein the sprocket comprises a sleeve portion sleeved on the driving shaft and a plurality of teeth extending axially from an outer surface of the sleeve portion, and each spring tongue extends into a gap between two adjacent teeth and presses against the chain.

6. The chain saw according to claim 2, wherein the sprocket comprises a sleeve portion sleeved on the driving shaft, a plurality of teeth axially extending from an outer surface of the sleeve portion, and an end portion connecting the plurality of the teeth, the extension member is configured as a protrusion block extending from an inner side wall of the end portion toward the chain and pressing against the chain, and the protrusion block is integrally formed with the end portion.

7. The chain saw according to claim 6, wherein the supporting assembly comprises a pressure plate that presses against the end portion, and the pressure plate is configured as a wavy elastic plate to compensate for the axial gap between the sprocket and the chain.

8. The chain saw according to claim 7, wherein the driving shaft extends axially out of the housing, the chain saw comprises a spacer connected to an axial end of the driving shaft, and the supporting assembly is elastically connected between the sprocket and the spacer to compensate for an axial gap between the sprocket and the spacer.

9. The chain saw according to claim 8, wherein the chain saw further comprises a stopper installed on an axial end of the driving shaft, a stop groove is defined at the axial end of the driving shaft, and the stopper is installed in the stop groove to limit axial movement of the spacer and the supporting assembly.

10. The chain saw according to claim 9, wherein the pressure plate of the supporting assembly is elastically installed between the sprocket and the spacer.

11. The chain saw according to claim 1, wherein the chain saw comprises a cover detachably connected on the housing and a pressing member fixed in the cover, and when the cover is connected to the housing, the pressing member presses against the guide plate.

12. The chain saw according to claim 11, wherein the pressing member comprises a fixing plate installed on an inner surface of the cover and a pressing portion extending from the fixing plate toward the guide plate, and when the cover is connected to the housing, the pressing portion axially presses against a rear end of the guide plate, so that the guide plate remains horizontal in the longitudinal direction.

13. The chain saw according to claim 12, wherein the fixing plate comprises a pair of installing arms arranged in parallel and connected to each other, and longitudinal rear ends of the two installing arms are connected to each other and provided with a connecting portion bent toward the cover.

14. A chain saw, comprising:
a guide plate extending in a longitudinal direction;
a chain sleeved on an outer periphery of the guide plate;
a housing;
a driving assembly arranged in the housing and the driving assembly comprising a driving shaft extending out of the housing;
a stopper connected to an axial end of the driving shaft; and
a sprocket connected to the driving assembly, and the sprocket located between the housing and the stopper, the chain at least partially wound around the sprocket;
wherein the chain saw comprises a supporting assembly connected to a driving shaft, the supporting assembly is elastically supported between the stopper and the sprocket or the chain.

15. The chain saw according to claim 14, wherein the supporting assembly comprises a pressure plate located between the stopper and the sprocket, and the pressure plate is configured as an elastic member to fill an axial gap between the stopper and the sprocket.

16. The chain saw according to claim 15, wherein the supporting assembly comprises a plurality of spring tongues extending axially from the pressure plate, and the spring tongue presses against the chain, so that a front end and a rear end of the guide plate are kept horizontal in the longitudinal direction.

17. The chain saw according to claim 15, wherein the sprocket comprises a sleeve portion sleeved on the drive shaft, a plurality of teeth for guiding the chain, and an end portion connected to the plurality of the teeth, and the pressure plate is located between the end portion and the stopper.

18. The chain saw according to claim 17, wherein the end portion comprises a protrusion block extending from an inner side wall of the end portion toward the chain and pressing against the chain, and the protrusion block is integrally formed with the end portion.

19. The chain saw according to claim 14, wherein the chain saw comprises a cover detachably connected to the housing and a pressing member fixed in the cover, and when the cover is connected to the housing, the pressing member presses against the guide plate.

20. The chain saw according to claim 19, wherein the pressing member comprises a fixing plate installed on an inner surface of the cover and a pressing portion extending from the fixing plate toward the guide plate, and when the cover is connected to the housing, the pressing portion axially presses against a rear end of the guide plate, so that the guide plate remains horizontal in the longitudinal direction.
